(19) United States
(12) Patent Application Publication
(10) Pub. No.: US 2026/0225286 A1
(43) Pub. Date: Aug. 6, 2026

(54) METHOD FOR RECOVERING POLYCARBONATE RECYCLING MATERIAL FROM POLYCARBONATE-CONTAINING WASTE

(71) Applicant: Covestro Deutschland AG, Leverkusen (DE)

(72) Inventors: Bernd Garska, Koln (DE); Joseph Scheithauer, Dusseldorf (DE); Christoph Bontenackels, Koln (DE); Thomas Kostadinov, Leverkusen (DE)

(21) Appl. No.: 19/151,121

(22) PCT Filed: Jan. 22, 2024
(86) PCT No.: PCT/EP2024/051418

§ 371 Date: Jul. 25, 2025

(30) Foreign Application Priority Data
Feb. 3, 2023 (EP) 23154888.4

(51) Int. Cl. B29B 17/04; B29B 17/00; B29B 17/02; B29K 69/00; B29L 31/00

(52) U.S. Cl. CPC B29B 17/04; B29B 17/02; B29B 2017/0015; B29B 2017/0468; B29K 2069/00; B29K 2995/0012; B29K 2995/0088; B29L 2031/753

(57) ABSTRACT

A process for recovering polycarbonate recycling material from polycarbonate-containing waste, especially from polycarbonate-containing medical and/or laboratory waste is provided. The recovering comprises the steps of: I) sterilizing, comminuting and washing the polycarbonate-containing waste to obtain a polycarbonate-containing material mixture, wherein the sterilizing, the comminuting and/or the washing are carried out at a temperature of 120° C. to 200° C. and a pressure of 1.5 to 15 bar; II) sorting the polycarbonate-containing material mixture according to the polycarbonate constituents to obtain the polycarbonate recycling material; III) optionally further processing the polycarbonate recycling material; wherein the melt volume flow rate MVR of the polycarbonate recycling material is 0.0% to 50.0% higher than that of the polycarbonate starting material of the polycarbonate-containing waste, wherein the melt volume flow rate MVR is in each case determined at 300° C. with a test weight of 1.2 kg according to DIN ISO 1133-1:2022.

### FIELD

The present invention relates to a process for recovering polycarbonate recycling material from polycarbonate-containing waste, especially from polycarbonate-containing medical and/or laboratory waste, to the polycarbonate recycling material obtained or obtainable by this process and to the use thereof.

### BACKGROUND

Recycling (also known as waste recovery) represents an interesting option for saving resources and reducing environmental impact. Ever more businesses in the Life Science/Healthcare sector are concerned, often for the aforementioned reasons and due to cost reasons and regulatory requirements, with reducing their emissions, especially the Scope 3 emissions generated at the end of the product lifecycle, and recycling concepts are thus also desirable in that sector. This is because recycling recovers so-called secondary raw materials (also known as recyclates) from the wastes which may then in turn be employed in a very wide variety of applications. However, it is important for the obtained recyclates to have usable material properties and to meet the regulatory requirements for use as a new product according to REACH (EC 1907/2006) with regard to the content of hazardous materials and Substances of Very High Concern (SVHC) in order that these may also be used as starting materials for further processing.

However, today, wastes from the Life Science/Healthcare sector (for example medical and laboratory products) continue to be to a very large extent incinerated. This is because these are the subject of strict regulatory requirements in many countries. This is especially true of infectious wastes. However, a majority of medical and laboratory wastes are only partly contaminated wastes. However, these wastes too are predominantly sent for disposal in incineration plants. However, these aforementioned wastes often contain products whose materials/inputs could be returned to the value product cycle after a decontamination, including in other applications. One of these materials/inputs which is employed in medical and laboratory products often and in large amounts is aromatic polycarbonate.

There is therefore a need for a process which makes it possible to obtain polycarbonate from polycarbonate-containing waste, especially from polycarbonate-containing medical and/or laboratory waste, wherein the obtained recyclate still has good or equivalent material properties and meets the regulatory requirements according to REACH (EC 1907/2006) for use as a product in the same or another application, for example also outside the medical technology sector.

### SUMMARY

It is accordingly an object of the present invention to provide a process for recovering polycarbonate recycling material from polycarbonate-containing waste, especially from polycarbonate-containing medical and/or laboratory waste. The obtained polycarbonate recycling material should especially be decontaminated and further exhibit good material properties and thus be able to be supplied to the value product cycle.

The problem is solved by a process for recovering polycarbonate recycling material from polycarbonate-containing waste, especially from polycarbonate-containing medical and/or laboratory waste, wherein the recovering comprises the steps of:
I) sterilizing, comminuting and washing the polycarbonate-containing waste to obtain a polycarbonate-containing material mixture, wherein the sterilizing, the comminuting and/or the washing are carried out at a temperature of 120° C. to 200° C. and a pressure of 1.5 to 15 bar;
II) sorting the polycarbonate-containing material mixture according to the polycarbonate constituents to obtain the polycarbonate recycling material;
III) optionally further processing the polycarbonate recycling material;
   wherein the melt volume flow rate MVR of the polycarbonate recycling material is 0.0% to 50.0% higher than that of the polycarbonate starting material of the polycarbonate-containing waste, wherein the melt volume flow rate MVR is in each case determined at 300° C. with a test weight of 1.2 kg according to DIN ISO 1133-1:2022.

### DETAILED DESCRIPTION

In the course of the development work leading to the present invention it was surprisingly found that the use of the aforementioned steps for recovering polycarbonate from polycarbonate-containing waste results in decontaminated recyclate having good material properties. The obtained polycarbonate recycling material can therefore be employed as starting material for various applications. The polycarbonate-containing waste thus need no longer be sent for disposal by incineration, thus markedly improving the emissions and environmental balance of the polycarbonate material.

In the context of the present invention polycarbonate-containing medical and/or laboratory waste is to be understood as meaning waste which derives from human or animal healthcare and research according to the European List of Waste AVV18 (List of Waste Chapter 18—WASTES FROM HUMAN OR ANIMAL HEALTH CARE AND/OR RELATED RESEARCH).

In the context of the present invention “polycarbonate recycling material” is to be understood as meaning the polycarbonate recovered from polycarbonate-containing waste, i.e. from polycarbonate-containing medical and/or laboratory waste, by the process according to the invention. The polycarbonate recycling material preferably consists of 50.0% to 100.0% by weight of polycarbonate, more preferably of 99.0% to 100.0% by weight, based on the total weight of the polycarbonate recycling material, wherein the polycarbonate preferably comprises or consists of aromatic polycarbonate.

In addition to polycarbonate constituents the polycarbonate-containing waste may also contain inter alia polysulfone fibers, labels, waste receptacles for transporting the contaminated waste, such as sacks, boxes, drums etc., especially waste sacks, polypropylene constituents, polyurethane constituents, inorganic constituents, especially metals, glass or mixtures thereof, thermoplastic materials, elastomeric materials and/or thermoset materials.

The mass fraction of polycarbonate in the total weight of the polycarbonate-containing waste is preferably at least from 20.0% to 100.0% by weight, more preferably from 20.0% to 90% by weight, yet more preferably from 30.0% to 80.0% by weight. In addition, the polycarbonate constituents of the polycarbonate-containing waste preferably contain or consist of aromatic polycarbonate. In the context of the invention the term “polycarbonate” is to be understood as meaning both aromatic homopolycarbonates and aromatic copolycarbonates. These polycarbonates may be linear or branched in the familiar manner. According to the invention it is also possible to use mixtures of polycarbonates.

Particulars pertaining to the production of polycarbonates are disclosed in many patent documents spanning approximately the last 40 years. Reference may be made here for example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertne, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117 to 299.

The sterilizing, the comminuting and/or the washing of the polycarbonate-containing waste in step I) is preferably carried out at a temperature of 120° C. to 150° C., more preferably of 130° C. to 140° C., yet more preferably of 134° C. to 138° C., and/or preferably a pressure of 1.5 to 4.0 bar, more preferably of 2.5 to 3.5 bar, yet more preferably of 3.0 to 3.4 bar. It is likewise preferable when the polycarbonate-containing waste is exposed to vapor, preferably steam, during the sterilizing, the comminuting and/or the washing.

Step I) according to the invention ensures that the constituents of the obtained polycarbonate-containing material mixture do not melt together and/or undergo clumping during the sterilizing, the comminuting and/or the washing but are nevertheless reliably decontaminated.

The polycarbonate-containing material mixture obtained in step I) is to be understood as meaning that the individual constituents do not melt together and/or undergo clumping during the sterilizing, the comminuting and/or the washing despite the high temperatures close to the heat distortion temperature of polycarbonate that are necessary for the sterilization.

The sorting of the polycarbonate-containing material mixture according to the polycarbonate constituents to obtain the polycarbonate recycling material may be carried out manually and/or using an automated sorting plant, wherein sorting using an automated sorting plant is preferably effected by density; sensor-based sorting, especially near infrared, mid infrared, visual, laser-based, X-ray and/or magnetic sensor-based sorting; an impact reactor; windsifting, by electrostatic means and/or by a sink float process.

It is further preferable when the polycarbonate starting material of the polycarbonate-containing waste has a melt volume flow rate MVR_{polycarbonate waste} of at most 50 cm³/10 min, preferably of 1 to 50 cm³/10 min, more preferably 5 to 35 cm³/10 min, determined at 300° C. with a test weight of 1.2 kg according to DIN ISO 1133-1:2022.

The melt volume flow rate MVR of the polycarbonate recycling material is preferably 0% to 40.0% higher than that of the polycarbonate starting material of the polycarbonate-containing waste, more preferably 0% to 35.0% higher, yet more preferably 0% to 30% higher. It is moreover preferable when the melt volume flow rate MVR of the polycarbonate recycling material is
0% to 20% higher than that of the polycarbonate starting material of the polycarbonate-containing waste when the polycarbonate starting material is a polycarbonate having an average molecular weight of 21 000 to 23 000 g/mol;
0% to 25% higher than that of the polycarbonate starting material of the polycarbonate-containing waste when the polycarbonate starting material is a polycarbonate having an average molecular weight of 23 000 to 25 000 g/mol;
0% to 35% higher than that of the polycarbonate starting material of the polycarbonate-containing waste when the polycarbonate starting material is a polycarbonate having an average molecular weight of 25 000 to 27 000 g/mol;
0% to 40% higher than that of the polycarbonate starting material of the polycarbonate-containing waste when the polycarbonate starting material is a polycarbonate having an average molecular weight of 27 000 to 29 000 g/mol;
and 0% to 45% higher than that of the polycarbonate starting material of the polycarbonate-containing waste when the polycarbonate starting material is a polycarbonate having an average molecular weight of 30 000 to 33 000 g/mol;
   wherein the average molecular weight is in each case determined by gel permeation chromatography (GPC) calibrated against bisphenol A polycarbonate standards using dichloromethane as eluent, calibration with linear polycarbonates (composed of bisphenol A and phosgene) of known molar mass distribution from PSS Polymer Standards Service GmbH, Germany; calibration according to method 2301-0257502-09D (2009 German Edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of the column material: 3 μm to 20 μm. Concentration of solutions: 0.2% by weight. Flow rate: 1.0 ml/min, temperature of solutions: 30° C. Use of UV and/or RI detection.

The optional processing of the polycarbonate recycling material in step III) preferably comprises a melt process, especially an extrusion, a pelletization and/or a compounding of the polycarbonate recycling material.

The invention further relates to a polycarbonate recycling material obtained or obtainable by the process according to the invention.

The invention finally also relates to the use of the polycarbonate recycling material according to the invention in or as pellet material, film, sheet and/or filament, especially in the automotive industry, electrical and electronics industry, furniture industry and/or medical technology.

### EMBODIMENTS

The invention especially relates to the following embodiments:

In a first embodiment the invention relates to a process for recovering polycarbonate recycling material from polycarbonate-containing waste, especially from polycarbonate-containing medical and/or laboratory waste, wherein the recovering comprises the steps of:
I) sterilizing, comminuting and washing the polycarbonate-containing waste to obtain a polycarbonate-containing material mixture, wherein the sterilizing, the comminuting and/or the washing are carried out at a temperature of 120° C. to 200° C. and a pressure of 1.5 to 15 bar;
II) sorting the polycarbonate-containing material mixture according to the polycarbonate constituents to obtain the polycarbonate recycling material;
III) optionally further processing the polycarbonate recycling material;
   wherein the melt volume flow rate MVR of the polycarbonate recycling material is 0.0% to 50.0% higher than that of the polycarbonate starting material of the polycarbonate-containing waste, wherein the melt volume flow rate MVR is in each case determined at 300° C. with a test weight of 1.2 kg according to DIN ISO 1133-1:2022.

In a second embodiment the invention relates to a process according to the first embodiment, characterized in that the polycarbonate-containing waste contains not only polycarbonate constituents but also polysulfone fibers, labels, waste receptacles for transporting the contaminated waste, especially waste sacks, polypropylene constituents, polyurethane constituents, inorganic constituents, especially metals, glass or mixtures thereof, thermoplastic materials, elastomeric materials and/or thermoset materials.

In a third embodiment the invention relates to a process according to the first or second embodiment, characterized in that the mass fraction of polycarbonate based on the total weight of the polycarbonate-containing waste is at least from 20.0% to 100.0% by weight, preferably from 20.0% to 90.0% by weight, more preferably from 30.0% to 80.0% by weight.

In a fourth embodiment the invention relates to a process according to any of the preceding embodiments, characterized in that the polycarbonate constituents of the polycarbonate-containing waste contain or consist of aromatic polycarbonate.

In a fifth embodiment the invention relates to a process according to any of the preceding embodiments, characterized in that the sterilizing, the comminuting and/or the washing in step I) is carried out at a temperature of 120° C. to 150° C., preferably of 130° C. to 140° C., more preferably of 134° C. to 138° C., and/or a pressure of 1.5 to 4.0 bar, preferably of 2.5 to 3.5 bar, more preferably of 3.0 to 3.4 bar.

In a sixth embodiment the invention relates to a process according to any of the preceding embodiments, characterized in that the polycarbonate-containing waste is exposed to vapor, preferably steam, during the sterilizing, the comminuting and/or the washing.

In a seventh embodiment the invention relates to a process according to any of the preceding embodiments, characterized in that the sorting of the polycarbonate-containing material mixture according to the polycarbonate constituents to obtain the polycarbonate recycling material is carried out manually and/or using an automated sorting plant, wherein sorting using an automated sorting plant is preferably effected by density; sensor-based sorting, especially near infrared, mid infrared, visual, laser-based, X-ray and/or magnetic sensor-based sorting; an impact reactor; windsifting, by electrostatic means and/or by a sink float process.

In an eighth embodiment the invention relates to a process according to any of the preceding embodiments, characterized in that the polycarbonate starting material of the polycarbonate-containing waste has a melt volume flow rate MVR_{polycarbonate waste} of at most 50 cm³/10 min, preferably of 1 to 50 cm³/10 min, more preferably 5 to 35 cm³/10 min, determined at 300° C. with a test weight of 1.2 kg according to DIN ISO 1133-1:2022.

In a ninth embodiment the invention relates to a process according to any of the preceding embodiments, characterized in that the melt volume flow rate MVR of the polycarbonate recycling material is 0% to 40.0% higher than that of the polycarbonate starting material of the polycarbonate-containing waste, more preferably 0% to 35.0% higher, yet more preferably 0% to 30% higher.

In a tenth embodiment the invention relates to a process according to any of the preceding embodiments, characterized in that the melt volume flow rate MVR of the polycarbonate recycling material is
0% to 20% higher than that of the polycarbonate starting material of the polycarbonate-containing waste when the polycarbonate starting material is a polycarbonate having an average molecular weight of 21 000 to 23 000 g/mol;
0% to 25% higher than that of the polycarbonate starting material of the polycarbonate-containing waste when the polycarbonate starting material is a polycarbonate having an average molecular weight of 23 000 to 25 000 g/mol;
0% to 35% higher than that of the polycarbonate starting material of the polycarbonate-containing waste when the polycarbonate starting material is a polycarbonate having an average molecular weight of 25 000 to 27 000 g/mol;
0% to 40% higher than that of the polycarbonate starting material of the polycarbonate-containing waste when the polycarbonate starting material is a polycarbonate having an average molecular weight of 27 000 to 29 000 g/mol;
and 0% to 45% higher than that of the polycarbonate starting material of the polycarbonate-containing waste when the polycarbonate starting material is a polycarbonate having an average molecular weight of 30 000 to 33 000 g/mol;
   wherein the average molecular weight is in each case determined by gel permeation chromatography (GPC; eluent dichloromethane, calibration against bisphenol A-Polycarbonate Standards).

In an eleventh embodiment the invention relates to a process according to any of the preceding embodiments, characterized in that the further processing comprises a melt process, especially an extrusion, a pelletization and/or a compounding of the polycarbonate recycling material.

In a twelfth embodiment the invention relates to a process according to any of the preceding embodiments, characterized in that the polycarbonate recycling material consists of 50.0% to 100.0% by weight of polycarbonate, preferably of 99.0% to 100.0% by weight, based on the total weight of the polycarbonate recycling material, wherein the polycarbonate preferably comprises or consists of aromatic polycarbonate.

In a thirteenth embodiment the invention relates to a polycarbonate recycling material obtained or obtainable by a process according to any of embodiments one to twelve.

In a fourteenth embodiment the invention relates to the use of a polycarbonate recycling material according to embodiment thirteen in or as pellet material, film, sheet and/or filaments, especially in the automotive industry, electrical and electronics industry, furniture industry and/or medical technology.

### EXAMPLES

The present invention is more particularly elucidated with reference to the following examples.

### Methods of Measurement:

The following methods of measurement were used:

### MVR Determination:

The melt volume flow rate (MVR) was in each case determined at 300° C. with a test weight of 1.2 kg according to DIN ISO 1133-1:2022.

### Experiment 1:

### Materials and Instruments:

### Polycarbonate-Containing Waste:

Dialyzers (Fresenius Hemoflow F7HPS and Fresenius plasmaFlux P2 dry) having a polycarbonate housing in which polysulfone filter fibers are embedded at the lateral ends using a polyurethane potting compound. The dialyzers also have a printed label. The material composition (altogether 207.5 g) is as follows:
Polycarbonate: 92 g of Makrolon® 2858 550115 (MVR (300° C./1.2 kg)=9.0 cm³/10 min) and 34 g of Makrolon® 2858 MAS020 (MVR (300° C./1.2 kg)=9.0 cm³/10 min) with an average molecular weight of 28 000 g/mol (altogether 60%);
Polysulfone fibers 9.5 g (5%);
Polyurethane potting compound: 72 g (35%).

### Experimental Procedure and Results:

The waste (20 kg) was placed into a MACS 800 from EET Ermafa Environmental Technologies GmbH and sterilized, comminuted and washed (in combination) with exposure to steam at temperatures of 136° C. and pressures of 3.2 bar over 1 hour. The obtained polycarbonate-containing material mixture was then manually sorted according to the polycarbonate constituents to obtain the polycarbonate recycling material (about 12 kg).

The MVR value of the obtained polycarbonate recycling material was then determined by the aforementioned method. This value was 10.3 cm³/10 min and is in the process range for a polycarbonate material having an average molecular weight between 26 000-28 000 g/mol. The obtained polycarbonate recycling material is accordingly very suitable for further processing.

### Experiment 2:

In a second series of experiments, analogously to experiment 1, the MVR values of polycarbonate samples made of Makrolon® 2405, Makrolon® 2807 and Makrolon® 3100 from Covestro AG, Leverkusen were examined after preceding contamination with porcine blood and subsequent processing according to the invention.

### Materials and Instruments:

Polycarbonate materials in each case made of Makrolon® 2405, Makrolon® 2807 and Makrolon® 3100 from Covestro AG, Leverkusen in different phases of customary processing, namely:
1. Unprocessed pellet material
2. Shredded injection molded sheets (based on pellet material from 1)
3. Sheets from 2) contaminated with porcine blood and sterilized and shredded.

Blood powder: Spray-dried porcine blood (manufacturer: SOLINA GERMANY GmbH, Bonn) for use in foodstuffs industry, obtained from mtg-gewuerze.de

Production of the sheet test specimens having a thickness of 3.2 mm for shredding and contaminating (see aforementioned processing phases 2+3) was carried out on a 720S injection molding machine from Arburg GmbH+Co KG, Loßburg in an injection molding process at a melt temperature of 300° C., a mold temperature of 100° C., a filling time of 1.6 seconds, a hold pressure of 200 bar, a hold pressure duration of 5.5 seconds, a residual cooling time of 48.0 seconds, a molding path of 2.4 mm, a molding force of 1500 kN and a molding duration of 53.5 s.

To contaminate the sheet test specimens (see aforementioned processing phase 3) the porcine blood used therefor was initially produced by mixing 1 kg of blood powder with 5 kg of lukewarm water. The test specimens were then stored in the made-up porcine blood for 1 hour in each case. The sheet test specimens contaminated with porcine blood (in each case 10 kg per material) were then placed into a MACS 800 instrument from EET Ermafa Environmental Technologies GmbH, comminuted using the shredder unit integrated in the machine and washed and sterilized (in combination) with exposure to steam over 1 hour at temperatures of 136° C. and pressures of 3.2 bar.

The samples were then subjected to an examination of their MVR values as in experiment 1. The results are summarized in the table which follows:

| | MVR (300° C./1.2 kg) [cm³/10 min] |
|---|---|
| Makrolon 2405 - Granules | 19.1075 |
| Makrolon 2405 - Injection molded | 18.3099 |
| Makrolon 2405 - Decontaminated | 20.3809 |
| Makrolon 2807 - Granules | 10.0121 |
| Makrolon 2807 - Injection molded | 10.3598 |
| Makrolon 2807 - Decontaminated | 11.0219 |
| Makrolon 3100 - Granules | 5.4737 |
| Makrolon 3100 - Injection molded | 5.7142 |
| Makrolon 3100 - Decontaminated | 7.5778 |

The results show that the employed samples have endured the contamination with blood and the subsequent processing according to the invention without appreciable molecular weight degradation.

1. A process for recovering polycarbonate recycling material from polycarbonate-containing waste, wherein the recovering comprises the steps of:
I) sterilizing, comminuting and washing the polycarbonate-containing waste to obtain a polycarbonate-containing material mixture, wherein the sterilizing, the comminuting and/or the washing are carried out at a temperature of 120° C. to 200° C. and a pressure of 1.5 to 15 bar; and
II) sorting the polycarbonate-containing material mixture according to the polycarbonate constituents to obtain the polycarbonate recycling material;
wherein the melt volume flow rate MVR of the polycarbonate recycling material is 0.0% to 50.0% higher than that of the polycarbonate starting material of the polycarbonate-containing waste, wherein the melt volume flow rate MVR is in each case determined at 300° C. with a test weight of 1.2 kg according to DIN ISO 1133-1:2022.

2. The process as claimed in claim 1, wherein the polycarbonate-containing waste contains not only polycarbonate constituents but also polysulfone fibers, labels, waste receptacles for transporting the contaminated waste, polypropylene constituents, polyurethane constituents, inorganic constituents, thermoplastic materials, elastomeric materials and/or thermoset materials.

3. The process as claimed in claim 1, wherein the mass fraction of polycarbonate based on the total weight of the polycarbonate-containing waste is at least from 20.0% to 100.0% by weight.

4. The process as claimed in claim 1, wherein the polycarbonate constituents of the polycarbonate-containing waste contain or consist of aromatic polycarbonate.

5. The process as claimed in claim 1, wherein the sterilizing, the comminuting and/or the washing in step I) is carried out at a temperature of 120° C. to 150° C. and/or a pressure of 1.5 to 4.0 bar.

6. The process as claimed in claim 1, wherein the polycarbonate-containing waste is exposed to vapor during the sterilizing, the comminuting and/or the washing.

7. The process as claimed in claim 1, wherein the sorting of the polycarbonate-containing material mixture according to the polycarbonate constituents to obtain the polycarbonate recycling material is carried out manually and/or using an automated sorting plant; sensor-based sorting; an impact reactor; and/or windsifting, by electrostatic means and/or by a sink float process.

8. The process as claimed in claim 1, wherein the polycarbonate starting material of the polycarbonate-containing waste has a melt volume flow rate MVR_{polycarbonate waste} of at most 50 cm³/10 min determined at 300° C. with a test weight of 1.2 kg according to DIN ISO 1133-1:2022.

9. The process as claimed in claim 1, wherein the melt volume flow rate MVR of the polycarbonate recycling material is 0% to 40.0% higher than that of the polycarbonate starting material of the polycarbonate-containing waste.

10. The process as claimed in claim 1, wherein the melt volume flow rate MVR of the polycarbonate recycling material is
0% to 20% higher than that of the polycarbonate starting material of the polycarbonate-containing waste when the polycarbonate starting material is a polycarbonate having an average molecular weight of 21,000 to 23,000 g/mol;
0% to 25% higher than that of the polycarbonate starting material of the polycarbonate-containing waste when the polycarbonate starting material is a polycarbonate having an average molecular weight of 23,000 to 25,000 g/mol;
0% to 35% higher than that of the polycarbonate starting material of the polycarbonate-containing waste when the polycarbonate starting material is a polycarbonate having an average molecular weight of 25,000 to 27,000 g/mol;
0% to 40% higher than that of the polycarbonate starting material of the polycarbonate-containing waste when the polycarbonate starting material is a polycarbonate having an average molecular weight of 27,000 to 29,000 g/mol;
and 0% to 45% higher than that of the polycarbonate starting material of the polycarbonate-containing waste when the polycarbonate starting material is a polycarbonate having an average molecular weight of 30,000 to 33,000 g/mol;
wherein the average molecular weight is in each case determined by gel permeation chromatography.

11. The process as claimed in claim 1, further comprising further processing the polycarbonate recycling material, wherein the further processing comprises a melt process, a pelletization and/or a compounding of the polycarbonate recycling material.

12. The process as claimed in claim 1, wherein the polycarbonate recycling material consists of 50.0% to 100.0% by weight of polycarbonate based on the total weight of the polycarbonate recycling material.

13. A polycarbonate recycling material obtained by the process as claimed in claim 1.

14. A pellet material, film and/or filament comprising the polycarbonate recycling material as claimed in claim 13.

15. The process as claimed in claim 1, wherein the polycarbonate-containing waste comprises polycarbonate-containing medical, laboratory waste, or a combination thereof.

16. The process as claimed in claim 1, wherein the mass fraction of polycarbonate based on the total weight of the polycarbonate-containing waste is at least from 20.0% to 90.0% by weight.

17. The process as claimed in claim 1, wherein the mass fraction of polycarbonate based on the total weight of the polycarbonate-containing waste is at least from 30.0% to 80.0% by weight.

18. The process as claimed in claim 1 wherein the sterilizing, the comminuting and/or the washing in step I) is carried out at a temperature of 130° C. to 140° C. and/or a pressure of 2.5 to 3.5 bar.

19. The process as claimed in claim 1 wherein the sterilizing, the comminuting and/or the washing in step I) is carried out at a temperature of 134° C. to 138° C. and/or a pressure of 3.0 to 3.4 bar.

20. The process as claimed in claim 1, wherein the polycarbonate starting material of the polycarbonate-containing waste has a melt volume flow rate MVR_{polycarbonate waste} of 5 to 35 cm³/10 min, determined at 300° C. with a test weight of 1.2 kg according to DIN ISO 1133-1:2022.
